(19) United States
(12) Patent Application Publication
(10) Pub. No.: US 2005/0080650 A1
(43) Pub. Date: Apr. 14, 2005

(54) System and method for meal distribution and dietary attention

(75) Inventor: Eric R. Noel, Portland, OR (US)

Correspondence Address: Anthony Claiborne, 849 136th Ave. N.E., Bellevue, WA, 98005, US

(73) Assignee: Restaurant Computer Systems, Inc., Portland, OR (US)

(21) Appl. No.: 10/683,672

(22) Filed: Oct. 9, 2003

(51) Int. Cl. G06F 17/60

(52) U.S. Cl. 705/2

(57) ABSTRACT

An integrated computerized system, for use particularly in a facility providing menu selected meals to patients, provides for ordering a meal appropriate to a specific patient, determining the status and whereabouts of the meal prior to its delivery to the patient, and tracking the dietary intake of the patient at the facility over time.

### BACKGROUND OF THE INVENTION

1. Field of the Invention.

This invention relates to the field of automated electrical health care management, specifically to a system and method for management of patient meal distribution and dietary intake in a health care facility such as a hospital.

2. Description of the Related Art

Management of the preparation and distribution of patient meals in a health care facility such as a hospital is an important, complex task, requiring the coordination of disparate sources of information. Ordering a meal appropriate to a specific patient, determining the status and whereabouts of the meal prior to its delivery to the patient's room, and tracking the dietary intake of the patient at the facility over time, are each significant processes in individual patient care and overall health care facility management. Proper management of these processes requires input, processing and coordination of data among medical, nursing and dietary or nutrition staff throughout the facility.

During a patient's stay at the facility, information specific to the patient is entered in the patient's “chart”, which in modem practice is a data repository within a database system, as data in a database management system maintained on the institution's computer network. Standards for such database systems have been widely adopted, including standards promulgated by Health Level 7 (HL7), located on the world wide web at www.HL7.org, one of several ANSI-accredited Standards Developing Organizations operating in the healthcare arena.

Among the various data included in or linked to the patient's chart is information regarding the patient's identity, gender, height, weight, and the like which are generally determined either by pre-existing data or by patient questionnaire. Further included in or linked to the chart is the room and bed assignment of the patient, typically initially determined by admissions staff, based upon the availability of vacant beds and the matching of the patient's medical needs to locations in the facility serving such needs. The room and bed assignment of a patient may be changed throughout the patient's stay at the facility, as determined either by nursing or hospital administrative staff, for changes in the patient's health care needs or for facilities management purposes. Further included in the patient's chart is information regarding diet that is specific to the patient, such as dietary restrictions or specific nutritional needs. Patient-specific diet information entered in the patient's chart is typically determined by hospital dieticians in consultation with other medical staff and may be changed over the course of the patient's stay to match changes in the patient's condition or specific events or developments in the patient's treatment, such as infant delivery or pending surgery.

Different institutions employ various methods for determining the components of a patient's meal. In the traditional prior art practice, a patient's meal is simply assembled on a tray by hospital staff under the direction of a dietician who determines meal components for a diet based upon the patient's general status (age, gender, height, weight, etc.) and specific dietary information, both of which are obtained from the patient's chart, without any item selection by the patient. To improve the patient's experience during the stay, however, an emerging trend in health care is to allow patients who are capable of doing so to select some or all of the meal's components. For proper dietary management, institutions allowing patient selection of meal items require the continuous oversight of nutritional staff to assure that each meal provides adequate nutrition while meeting the patient's specific dietary needs and restrictions.

As is familiar to those of skill in the dietary arts, diet is generally specified in terms of amounts nutrient constituents or food groups over time, based upon scientifically established values appropriate for the individual. For example, the Food and Nutrition Board of the National Academy of Sciences (NAS) has published a set of reference values, the Dietary Reverence Intakes (DRI), comprising a set of reference values for specific nutrients applicable to individuals in particular groups. Included in such values are the following:
Recommended Dietary Allowance (RDA): the average daily nutrient intake level sufficient to meet the nutrient requirement of nearly all (97 to 98 percent) healthy individuals in a particular life stage and gender group.
Adequate Intake (AI): the recommended average daily intake level based on observed or experimentally determined approximations or estimates of nutrient intake by a group (or groups) of apparently healthy people that are assumed to be adequate, used when an RDA cannot be established.
Tolerable Upper Intake Level (UL): the highest average daily nutrient intake level that is likely to pose no risk of adverse health effects to almost all individuals in the general population. As intake increases above the UL, the potential risk of adverse effects may increase.
Estimated Average Requirement (EAR): the average daily nutrient intake level estimated to meet the requirement of half the healthy individuals in a particular life stage and gender group.

The RDA or EAR of a nutrient for individual is dependent upon the gender and age or stage of life of the individual. For example, recommended EARs indicate that man of average size should eat 57 grams of protein daily. To support their rapid development, infants and young children require relatively more protein than do adults. A three-month-old infant requires about 13 grams of protein daily, and a four-year-old child requires about 22 grams. Once in adolescence, sex hormone differences cause boys to develop more muscle and bone than girls; as a result, the protein needs of adolescent boys are higher than those of girls consumption (Dietary Reference Intakes for Energy, Carbohydrate, Fiber, Fat, Fatty Acids, Cholesterol, Protein, and Amino Acids (Macronutrients), Standing Committee on the Scientific Evaluation of Dietary Reference Intakes, Food and Nutrition Board, Institute of Medicine, 936 pages, 2002).

Many nutrients are required at low intake levels but can be harmful to an otherwise healthy individual at higher levels. By way of example, at present the NAS has set the nutritional component calcium at an Al level of 1000 mg to 1200 mg. per day for an average individual to reduce the risk of osteoporosis, while setting a UL of 2500 mg. per day to avoid adverse health effects of excess calcium consumption (Dietary Reference Intakes for Calcium, Phosphorus, Magnesium, Vitamin D and Fluoride, Standing Committee on the Scientific Evaluation of Dietary Reference Intakes, Food and Nutrition Board, Institute of Medicine, 448 pages, 1999). Similarly, while it is known that healthy adults require 500 to 1000 mg. of sodium daily, the Joint National Committee on Prevention, Detection, Evaluation, and Treatment of High Blood Pressure recommends limiting sodium intake to no more than 2300 mg. daily.

As is also well known in the dietary art, the dietary requirements for many individuals with medical conditions may differ from those of healthy individuals. Patients with high blood pressure may need to restrict sodium intake to a level lower than the recommended 2300 mg. daily limit for healthy individuals. Persons with medical conditions affecting the absorption, use and excretion of copper, such as some patients with obstructed bile flow, may require a diet that restricts intake of dietary copper to 1.2 mg. daily or less. Patients suffering from hyperphosphatemia caused by kidney disease may need to restrict dietary phosphorus to a very low level. For some conditions, it is recommended that patients avoid consumption of certain nutrients of food constituents altogether. For example, some patients with calcium oxalate kidney stones are urged to avoid entirely any oxalate-containing foods, including beets, chocolate, coffee, cola and rhubarb.

Because of the large number of variable nutritional requirements and dietary restrictions that a patient at a health care facility may have, the task of monitoring a patient's dietary intake is complex, particularly when the patient rather than the dietician determines meal components.

Another complex and data-intensive task related to the provision of meals at an institution concerns the tracking of a meal prior to delivery to the patient. From the time the meal components have been determined and the tray is assembled until the meal is delivered to the patient's room, it is often desirable to determine the status of a patient's tray, both to expedite delivery and to determine an estimated time of arrival for the meal. Prior art practice generally requires the party seeking such status to make inquiries along the chain of custody of the tray until its location is determined. While implementation of systematic meal delivery procedures, as in some institutions, may simplify such an inquiry, the prior art does not provide a simple and reliable method to obtain the status of every patient's tray pending delivery.

What is needed is an automated arrangement for management of the complex health care processes involved in patient dietary monitoring, meal preparation and delivery.

### OBJECTS AND ADVANTAGES

It is an object of the present invention to provide an integrated system for ordering a meal appropriate to a specific patient, determining the status and whereabouts of the meal prior to its delivery to the patient's room, and tracking the dietary intake of the patient at the facility over time.

It is a further object of this invention to provide such a system enabling the ordering of patient meals by institution staff.

It is a further object of this invention to provide such a system accommodating embodiments with user interface enabling rapid and simple user determination of a given patient's order status, tray status and dietary intake status.

It is a further object of this invention to provide such a system accommodating the selection by a patient of at least some meal items from a menu of choices.

It is a further object of this invention to provide such a system accommodating the specification of restrictions on dietary constituents for a patient.

It is a further object of this invention to provide such a system that further determines whether a patient's diet has exceeded specified dietary restrictions.

It is a further object of this invention to provide such a system with embodiments accommodating the specification of dietary requirements for a patient.

It is a further object of this invention to provide such a system, for embodiments accommodating specification of a patient's dietary requirements, that further determines whether a patient's diet has met the patient's dietary requirements.

It is a further object of this invention to provide such a system accommodating a database of meal menu items with corresponding nutrient constituent values.

It is a further object of this invention to provide such a system with embodiments accommodating a database of meal menu items with corresponding nutritional values.

It is a further object of this invention to provide such a system for tracking the status and whereabouts of a given patient's tray utilizing a method of tray coding and tray station data input.

It is a further object of this invention to provide such a system in networked form.

It is a further object of this invention to provide such a system in which at least some client device may at least temporarily be mobile for mobile data entry purposes.

These and other objects of the invention will be apparent to those skilled in this art from the detailed description of preferred embodiments of the invention to follow.

### BRIEF SUMMARY OF THE INVENTION

The present invention is an integrated computerized system, for use particularly in a facility providing menu selected meals to patients, for ordering a meal appropriate to a specific patient, determining the status and whereabouts of the meal prior to its delivery to the patient, and tracking the dietary intake of the patient at the facility over time.

The invention provides means for input and database management of certain information regarding patients and beds in the facility. It comprises a means for input and database management of a database of patient information, including patient identity, patient bed location within the facility, and dietary constituent restrictions, if any, specific to the patient. The patient information database further includes means for accumulating a given patient's intake over a given time of at least those dietary constituents that are restricted for that patient. In some embodiments, the database of patient information further includes information on at least some dietary requirements specific to the patient. In such embodiments, the patient information database further includes means for accumulating a given patient's intake over a given time of at least those dietary requirements that are specified for that patient. The invention further comprises a means for input and database management of a database of information providing the location and vacancy status of all beds within the facility, correlated with patient identity information to provide the identity of patients in occupied beds.

The invention further provides means for input and database management of certain information regarding meal menu items. It comprises a means for input and database management of a database of meal components, comprising at least currently available meal menu items and corresponding values of at least some dietary constituents for at least some of such meal menu items. In some embodiments, the meal component database further includes information on nutritional values corresponding to at least some meal menu items.

The invention further provides a user interface for meal menu item selection for an upcoming meal for a given patient. User input menu item selection data for a patient is correlated and processed with relevant entries in the meal component database and the patient information database. In preferred embodiments, prior to designating a selected meal menu item as a component of the patient's meal, appropriate dietary constituent accumulators in the relevant patient database record are queried to determine whether intake of the menu item, based upon its data in the meal menu item database, may cause an accumulated value for a restricted dietary constituent to exceed restrictions specified for that constituent for that patient. In such embodiments, if the selected menu item would cause the patient to exceed specified restrictions, the user interface provides a warning to the user, who may then choose to select an alternative item which does not cause the patient to exceed specified restrictions. Similarly, for embodiments providing for tracking a patient's dietary requirements, the user interface may provide an indication as to whether specific requirements have been met, providing guidance to the user in menu item selection.

The system further provides a means, cooperative with the user interface, of determining when a menu item is to be a component of a patient's meal. When it is determined that a selected menu item is to be a meal component, the system provides patient meal component data whereby the dietary constituent accumulators in the patient information database entry for the patient are appropriately incremented. In embodiments providing for the tracking of patient dietary requirements, the dietary requirement accumulators in the patient information database entry for the patient are also appropriately incremented.

The system further provides an output means for indicating to meal preparation staff the identity of the patient for whom the meal is ordered and the meal components selected. Meal preparation staff assemble the meal components on a tray designated for the patient.

The system further provides a means for determining the status and approximate location of a tray at any time pending delivery. The system provides a means for tagging the patient's tray with an identifier indicating the patient for whom the meal is prepared.

At appropriate locations between the site of meal preparation and the patient's bed, input means are provided for timely providing the system with tray identifier data and, in some embodiments, status data (e.g. order taken, in preparation, pending delivery, etc.) by input location. The system further provides a means for database management of the tray status and location data thereby obtained.

The system further provides user interface means and database inquiry, processing and output means for a user to inquire and obtain information regarding: vacancy status of facility beds; identity of a patient in an occupied bed; in some embodiments at least the most recent meal ordered for a patient; the status and location of a meal tray pending delivery to a patient, if any; the patient's current accumulated intake levels of restricted dietary constituents; and, in some embodiments, the patient's current accumulated intake values of dietary requirements.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a diagram of an exemplary computer system employed by the present invention.

FIG. 2 is a diagram of a network embodiment of the present invention.

FIG. 3 is an entity relationship diagram for a patient database supporting the invention.

FIG. 4a is an entity relationship diagram for a menu database supporting the invention.

FIG. 4b is an entity relationship diagram for a meal order database supporting the invention.

FIG. 4c is an entity relationship diagram for an alternative menu item record embodiment in a menu database.

FIG. 5 is an entity relationship diagram for a bed database supporting the invention.

FIG. 6a is a flow chart for the user interfaces providing operation of the system for its principal functions in the exemplary embodiment.

FIG. 6b is a depiction of an exemplary floor display interface.

FIG. 6c is a flowchart for an exemplary add new patient interface.

FIG. 7a is a flowchart for the room number and name interface of the exemplary embodiment.

FIG. 7b is a flowchart for the tray status interface of the exemplary embodiment.

FIG. 7c is a flowchart for the dietary values interface of the exemplary embodiment.

FIGS. 8a, 8b, and 8c are flowcharts for the different aspects of the meals interface of the exemplary embodiment.

FIG. 8d shows the principal components of the meal order entry interface of the exemplary embodiment.

FIG. 9 is a flowchart for the current meal order interface in the meal order entry interface of the exemplary embodiment.

FIG. 10 is a flowchart for batch processing of patient data to create automatic snack entries in the meal order database in the exemplary embodiment.

### DETAILED DESCRIPTION OF THE PREFERRED EMBODIMENTS

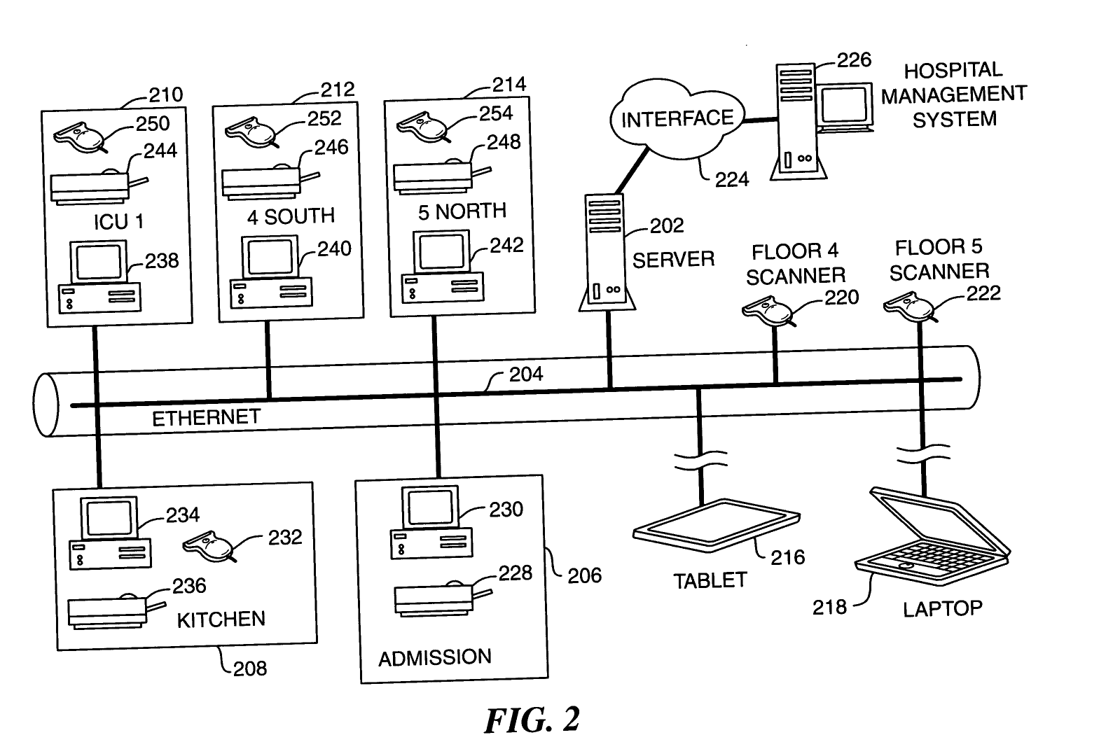

The present invention relates to a computerized system for management of patient meal distribution and dietary intake in a health care facility. While such a system may be implemented on a single stand-alone computer, in a typical installation the system will be implemented as software running on computers that are networked in client-server configuration, as described in more detail in reference to FIG. 2 below.

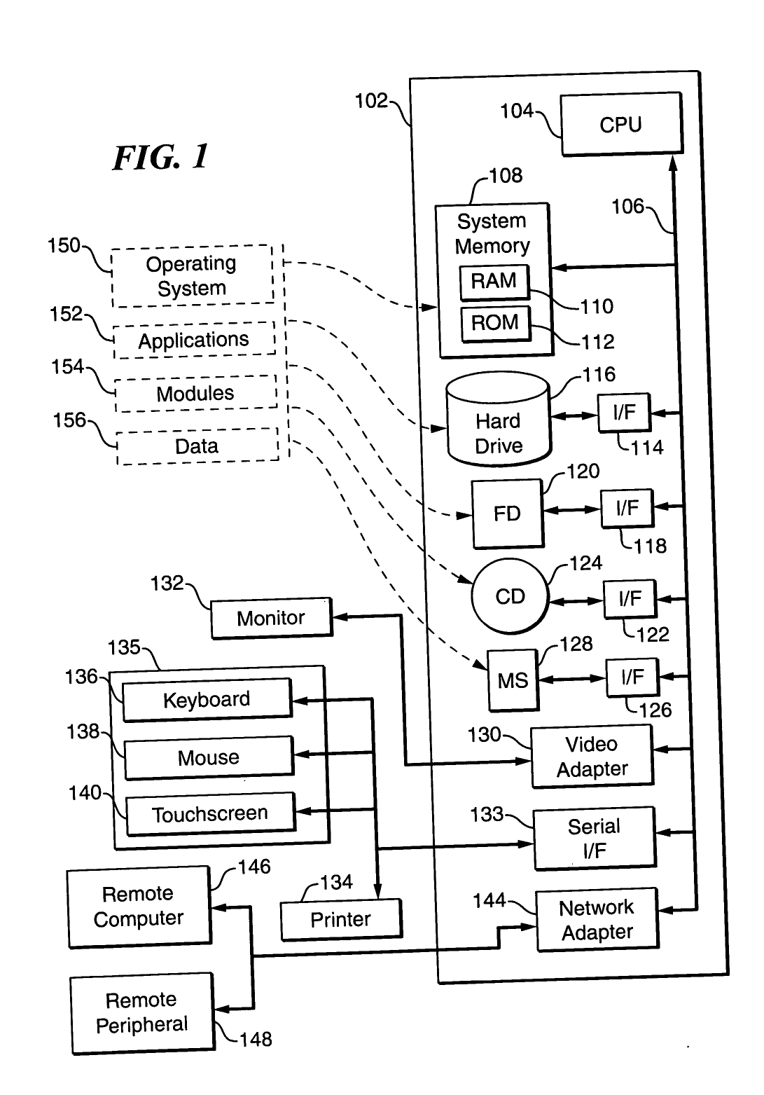

Referring now to FIG. 1, depicted is a computer system applicable to the stand-alone computer or to the client and server computers supporting the invention. As will be appreciated by those of skill in the art, the precise configuration of the computer system may vary considerably and the depicted system is merely exemplary of such systems generally.

The computer system comprises a computer 102 including a central processing unit 104 utilizing system bus 106 for storing and retrieving data and communicating control signals with system components. Computer 102 further includes system memory 108 in communication with CPU 104 via bus 106, memory 108 further comprising random access memory 110 and read-only memory 112.

Computer 102 further includes devices for long term storage and retrieval of data, including magnetic means such as hard drive 116 and floppy drive 120, respectively interfaced with CPU 104 over system bus 106 via hard drive interface 114 and floppy drive interface 11 8. Computer 102 may include devices for optical storage and retrieval of data, such as optical disk drive 124, interfaced with system bus 106 via optical disk drive interface 122. Optical disk drive 124 may be read-only, allowing only retrieval but not storage of data, or drive 124 may be read-write, allowing rewriting of data on compact disks adapted for such purpose. Optical disk drive 124 may employ CD-ROM format for data storage, or drive 124 may employ DVD or other format allowing more data to be written to a single disk. Computer 102 may further include removable solid state electronic devices for long term storage and retrieval of data, such as memory stick 128, interfaced 126 to CPU 104 over system bus 106. A number of computer software modules implementing the present invention, including software for providing the user interface and database management of the present invention, may be stored in RAM 110 and long term storage devices 116, 120, 124 and 128, including an operating system 150, one or more application programs 152, other program modules 154, and program data 156.

Computer 102 further provides for visual data output to a user via video adapter 130 driving monitor 132. As will be appreciated by those in the art, monitor 132 may be any means for rendering output signals from an appropriate video adapter 130, including a CRT or flat screen monitor technology such as liquid crystal or plasma display technology.

Employing serial interface 133, and a suitable serial protocol, such as Universal Serial Bus protocol, computer 102 may also drive a printer 134, such as a thermal, dot matrix, inkjet or laser printer. As is well known to those of skill in the art, other serial protocols such as RS232 or IEEE-48, and other interfaces such as a Centronics parallel interface (not illustrated) may be used for computer system 102 to control printer 134.

Computer 102 also includes interfaced user input devices 135, such as keyboard 136, mouse 138 or touchscreen 140. As illustrated, computer 102 interfaces with input devices 135 via serial interface 133. However, as will be appreciated by those in the art, any of user input devices 135 may also interface directly to bus 106, for example as in the case of an appropriate mouse device (not illustrated) interfaced to computer 102 via an IBM PS/2 mouse port integral to computer 102.

Computer 102 also includes network adapter 144 providing a network connection for computer 102 to communicate with remote computer 146 and remote peripheral device 148 (such as a network printer). In the preferred embodiment discussed with reference to FIG. 2 below, computer 102 is connected via network adapter 144 to a Local Area Network (LAN) providing access to remote computer 146 and remote peripheral 148. As will be appreciated by those in the art, the underlying media for an appropriate LAN may be varied, including optical fiber and copper wire, as well as wireless network connection such as limited or high bandwidth radio frequency, while keeping with the spirit of the present invention. Furthermore, an embodiment of the present invention may employ any one of various LAN protocols and topologies, including token ring and ethernet topologies. As will be understood by those in the art, computer network configurations applicable to the present invention may include Wide Area Networks, such as the Internet, in addition or in the alternative to a LAN, in which case computer 102 employs a form of modem (not depicted) such as a telephone line modem, digital subscriber line modem, or cable modem for network connection, typically interfaced to computer 102 via a serial interface, instead of network adapter 144.

Software comprising an operating system 150, applications 152, modules 154 and data 156 is represented throughout memory 108 and storage devices 116, 120, 124 and 128. Well known to those in the art, operating system 150 is computer software which, when executed by CPU 104, handles the interface to peripheral hardware, schedules tasks, allocates storage, and presents a default interface to the user when no application program is running. Application programs 152 are complete, self-contained programs that performs a specific functions directly for the user. Program modules 154 are independent pieces of software which each form part of one or more larger programs. Data 156 are representations of information that is processed by computer 102.

The present invention is a computer software implementation on an operating system 150, such as an appropriate Microsoft Windows® , Linux, or Unix operating system. In embodiments employing a LAN, operating system 150 must be chosen and configured to support the network. The software implementing the invention comprises applications 152, modules 154 and data 156, which when processed by the system with appropriate input, provide the invention's functionality.

Turning to FIG. 2, illustrated is an exemplary implementation of the present invention on an ethernet Local Area Network. Server computer 202 is linked via ethernet network 204 to other computers on the LAN implementing the present invention. Some of the other computers employed by the present invention are permanently located and connected to the LAN at specific key locations in the hospital. In some implementations, the fixed computers are in one or a few locations centralized for computer access, while in other implementations the fixed computers may be located at various points convenient for staff use, such as at nurse's stations. In addition to the fixed computers, other computers, which are portable, may be either removably or wirelessly connected to ethernet 204.

Illustrated in FIG. 2 are fixed computers 230, 234, 238, 240 and 242 at the following key locations respectively: Hospital Admission 206 ; Kitchen 208 ; ward ICU1 210 ; ward 4 South 212 ; and ward 5 North 214. The specific location for each such permanently connected computer may be determined by implementation requirements specific to the hospital, as further explained below. A printer 228, 236, 244, 246, and 248 is also operative at each such location, either as a system printer for computer 230, 234, 238, 240 and 242, or as a networked peripheral for network 204. Further, at the kitchen location 208 and at each ward location 210, 212 and 214, a bar code or other scanner 232, 250, 252, 254 is operative, again either as a system scanner for computer 234, 238, 240 and 242, or as a networked peripheral for network 204.

Portable computers, illustrated in FIG. 2 as tablet computer 216 and laptop computer 218, may be removably connected to ethernet 204 by a conveniently located docking station or the like as is well known to those of skill in the art. In embodiments providing for removable connectivity, the system software provides that portable computers 216, 218 may be operated as autonomous, stand-alone computers for the input of user data that, when computers 216, 218 are reconnected to the network, is reconciled with and merged into data residing on server 202. In the alternative, network 204 may provide at least some connected devices with wireless connectivity on a wireless connection of suitable bandwidth, such as the radio frequency IEEE 802.11 protocol. If wirelessly connected, portable computers 216 and 218 may be moved throughout the facility while maintaining network connectivity.

Further connected to ethernet 204 are strategically located scanners, represented in FIG. 2 as Floor 4 scanner 220 and Floor 5 scanner 222. As will be appreciated by those of skill in the art, scanners 220, 222 may be stand alone bar code scanners connected to ethernet 204 as networked peripherals, or they may system peripherals to computers (not depicted) connected to the ethernet at the appropriate location.

Server 202 is further connected via interface 224 to the hospital management system 226, such as the Hospital Information System (HIS) from Medinous Hospital Management Systems of Edison, N.J., or, as is more common in practice, a custom designed set of database applications specific for management of the hospital, running in a database management system maintained on the institution's computer network, and containing among other data, patient information such as a medical chart for the patient. As will be appreciated by those in the art, interface 224 may comprise a synchronous or asynchronous more or less real-time interface, or it may comprise batch processing of data files. Interface 224 may be a Local Area Network interface, a Wide Area Network interface, or may simply be implemented by the transport of files on removable memory media such as magnetic diskettes, optical disks such as CD-ROM or DVD, solid state electronic memory devices such as memory sticks, and the like, such files physically transported between server 202 and hospital management system 226. In any case, interface 224 provides at least one-way communication of data from hospital management system 226 to server 202. In some embodiments, interface 224 provides two-way communication of data between hospital management system 226 and server 202.

Still referring to FIG. 2, what follows is a brief summary of the operation of the system to illustrate the cooperation of the different components in network 204. Software and data structures supporting system operation are discussed in more detail later in reference to subsequent figures.

When a patient is first admitted to the facility, patient information is determined (typically by admission 206) and stored on server 202. Included in such patient information is the identity of the patient and the patient's initial bed assignment at the facility. The manner in which such information becomes stored on server 202 may vary. In some embodiments, such information is entered directly by admission 206 into networked computer 230 which transmits the information via network 204 to server 202. In other, perhaps more typical embodiments (not illustrated), admission 206 enters such information via a terminal on hospital management system 226, which in turn transmits the patient information to server 202 via interface 224.

Information regarding a patient's dietary restrictions, if any, and (in some embodiments) the patient's dietary requirements, is also stored on server 202. The source of such information within the institution and the manner in which it becomes stored on server 202 may vary, depending upon embodiment and configuration. Typically, dietary restrictions and requirements specific to a patient are determined by medical staff and entered by personnel from either medical, nursing, or administrative staff according to the procedural practice of the specific institution. In a typical configuration, this information may be entered directly into the system via an appropriate client computer (e.g. 216, 218, 230, 234, 238, 240, 242) on network 204. Alternatively, this information may be entered into the patient's chart on hospital management system 226 and transmitted to server 202 via interface 224.

The patient's bed location and/or the patient's current dietary restrictions and requirements may change during the course of the patient's stay at the facility. In a manner similar to initial patient information data entry, the patient information stored in server 202 may be changed appropriately during the patient's stay either by direct entry of such information from an appropriate client computer on network 204, or by entry of such information in hospital management system 226 for transmission via interface 224 to server 202.

Information regarding meal menu items, including the identity and certain nutritional information about such items, is also stored on server 202. Again, the source of such information within the institution and the manner in which it becomes stored on server 202 may vary, depending upon embodiment and configuration. In the case of meal menu items, such information is typically determined by institution dietary staff and may be entered and/or updated by dietary or administrative staff via an appropriate client computer (e.g. hospital kitchen computer 234) on network 204 for storage on server 202.

Selection of specific meal menu items for a patient may be accomplished in several ways. In the case of patient selection of menu items, a patient may use a telephone in the patient's room to call institution staff, for example in the kitchen 208, and order a meal. In such case, institution staff receiving the order enter it into the system, typically via kitchen computer 234. Clear to those of skill in the art, in other embodiments (not illustrated), the patient may employ an input device in or near the patient's room for ordering meals. Such a device may be a networked peripheral such as a touchscreen or dumb terminal, or it may be a client computer, perhaps of limited capabilities (thin client) in the patient's room or nearby. As will be further appreciated by those of skill in the art, such a device may be networked directly on system network 204 or may be connected to another network that is interfaced to network 204. In various other embodiments (also not shown) patient input of meal selection may alternatively be implemented by a two way user interface running on the institution's cable television system, by an automated telephone system employing touch tone or voice recognition technology, or by any number of other methods of obtaining such user input of meal menu item selection.

Alternatively, institution staff such as nursing or administrative staff may visit a patient's room and take the patient's meal order using a mobile computer system 216, 218. Further, in the case of patients who are not able or not available to place their own meal orders, a meal may be determined for the patient by institution dietary or nursing staff and entered into the system from any computer in the system, typically from a computer employed by meal preparation staff (for example computer 234 in kitchen 208) or from a computer at a nurse's station (for example, computer 238, 240, 242 at a nurse's station 210, 212, 214 respectively).

The meal order data received by the system typically comprises the patient's name and room number, the type of meal (e.g. breakfast, lunch, dinner, snack, etc.), the list of selected menu items, and the ready@ time, which specifies a time and date when the selected meal is expected to be delivered. When a patient's meal order has been received by the system, the order data may be stored in server 202 for later fulfillment, which may occur automatically based upon system processing of ready@ times for meal order data records. Alternative embodiments may simply process order data for fulfillment at the time the order is taken.

In any case, at the time of order fulfillment, the patient's meal order data is transmitted over network 204 to the kitchen 208 for preparation of the patient's tray containing patient meal components. Information of the selected meal components is presented to kitchen staff for preparation, via display monitor on kitchen computer 234, or by printed list from kitchen printer 232, or by any of the various means of presenting information from a computer system known to those of skill in the art. As the patient's meal components are identified, the tray upon which the components are assembled is designated as specific to the patient.

In one embodiment, at the time kitchen 208 receives information regarding the patient's selected meal components, kitchen printer 234 prints a bar-coded label which is then placed on or affixed to the patient's tray. The bar code on the label identifies the tray as specific to the patient who placed the order.

In another embodiment, each tray begins with its own machine readable code, such as a bar code printed on the tray, or an integral or attached transmitter or transponder device for radio frequency identification employing technology such as TI-RFID or TIRIS from Texas Instruments Incorporated of Dallas, Texas. In such embodiments, when the tray is selected for assembly of meal components for a given patient, the code on the tray is scanned by scanner 232 for server software to associate that tray with the patient's meal.

In any case, the patient's coded meal tray may be tracked using scanners located at scanning points disposed along the way to delivery in the patient's room. In preferred embodiments, institutional procedures require the scanning of trays at scanning points 208, 220, 222 as the trays are transported from the site of meal component assembly 208 to the patient's room. Networked scanners, which may be located in the kitchen 208 and at appropriately selected subsequent points, here illustrated as floor 4 scanner 220 and floor 5 scanner 222, read the machine-readable code on the tray and provide information to server 202 of the tray's whereabouts. As will be appreciated by those of skill in the art, it may be optimal to select a minimum number locations for scanning points for economy and administrative efficiency while still providing the system with satisfactorily detailed information on a tray's whereabouts. Alternatively, a tray may be tracked at a specific position by manual entry of the tray identifier on a client computer 216, 218, 230, 234, 238,240,242.

It will be noted by those of skill in the art that, while description of the preferred embodiments of the system include means for meal order entry and fulfillment, embodiments of the present invention may implement the meal tracking and dietary attention functionality of the invention when actual meal order entry and fulfillment occur via systems external to the invention, provided such external systems pass the information necessary for such functionality to the system, as via interface 224.

Software user interface implementations on client computer 216, 218 230, 234, 238, 240, 242 interacting with database applications running on server 202 enable a user of such client computers to perform queries and updates on the vacancy status of facility beds, the identity of a patient in an occupied bed, restrictions and requirements in a patient's diet, the present status of a patient's tray pending delivery, and the items selected for a patient's meal pending preparation. The system further enables a user to review the current accumulated intake values for designated dietary components of a patient. In some embodiments, the system further provides a user interface for ordering a meal for a patient, providing warning indications when a selected meal item would cause the patient to exceed a dietary restriction, and, in some embodiments, providing an indication of accumulated dietary requirements as menu items are selected. These and other aspects of the user interface afforded by the present invention will be clear to those of skill in the art from the following discussion.

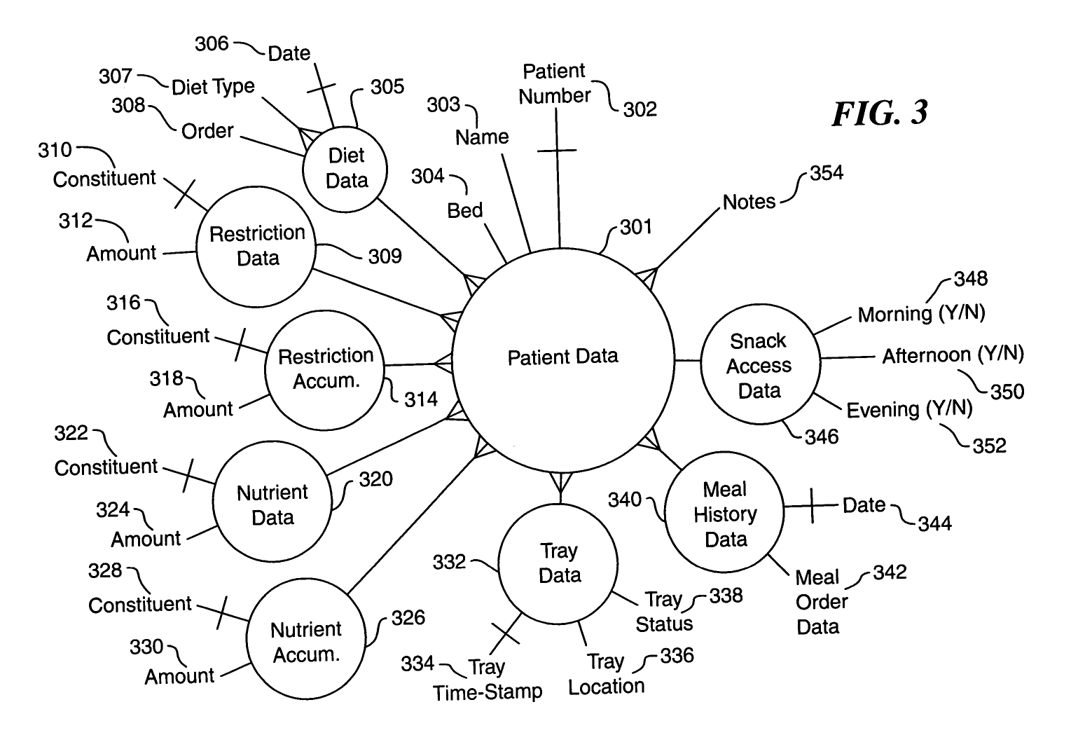

Turning now to FIGS. 3, 4 and 5, illustrated are entity relationship diagrams for various database components of the present invention. In such diagrams, one-to-many and many-to-one relationships are indicated by appropriately directed crow's feet indicators. Further, the key data element, if any, connected to a data entity is indicated by short line perpendicular to the connecting line between the key element and the data entity.

FIG. 3 depicts the entity relationships for patient data. A patient data record 301 s keyed by patient number 302 assigned to the patient, typically by the hospital management system. Patient data record further comprises the patient name 303 and currently assigned bed location 304 within the facility. As described earlier in reference to FIG. 2, patient bed data 304 for a given patient may be changed during the course of the patient's stay if and when the patient is moved to a different bed.

The patient data record also includes diet database 305 of diet types 307 that have been designated as appropriate for the patient, keyed by the date 306 such diet was selected for the patient. Diet types are selected from one of many diet regimens specified by institution dieticians. Examples of diet type are regular, diabetic, low sodium, low fat, and the like. For a given patient, institution medical or nutritional staff may designate a number of simultaneous diet types 307 appropriate for the patient's condition, forming a composite diet. Patient diet database 305 further comprises diet order 308, typically a text entry of the medical staff dietary orders for the patient.

The patient data record further includes restriction data 309, comprising perhaps a plurality of records keyed to restricted dietary constituents 310 specific to the patient, each including the amount 312 of intake of the keyed constituent 310 allowed for the patient over a given time. The patient data record further includes restriction accumulator(s) 314, comprising records equal in number at least to the number of restricted constituents 310 in the restriction data 309, the records keyed to restricted dietary constituents 316 including all of restricted dietary constituents 310, each record including an accumulated amount 318 of restricted dietary constituent 316 consumed by the patient over a given time. It should be noted and appreciated by those of skill in the art that restriction accumulators 314 may be many in number for tracking every dietary component of interest to the institution's dietary staff, regardless of whether such component is a dietary constituent 310 specific to any patient.

Analogously to tracking dietary restrictions, for embodiments accommodating tracking of patient dietary requirements, nutrient data 320 comprises perhaps a plurality of records keyed to required dietary constituents 322 specific to the patient, each including the amount 324 of intake of the keyed constituent 322 required for the patient over a given time. For such embodiments, the invention provides nutrient accumulator(s) 326, comprising records equal in number at least to the number of required constituents 322 in the nutrient data 320, the records keyed to required dietary constituents 328 including all of required dietary constituents 322, each record including an accumulated amount 330 of required dietary constituent 328 consumed by the patient over a given time.

Although not illustrated, it will be clear to those of skill in the art that the data structures for accumulators 314 and 326 may be elaborated to provide not only a patient's current accumulations for dietary constituents, but in addition may provide historical data on patient dietary intake at the institution over time. Furthermore, throughout this specification, for the purposes of simplicity and clarity it is assumed that the time period in which values are accumulated in the accumulators is one day, i.e. that the intake values are all daily intake values. Software processes described further in this specification set forth a manner in which the accumulators may be reset daily. However, a person of ordinary skill in the art may construct more elaborate data structures for accumulators 314 and 316 that provide for accumulation of individual constituents over various time periods, fashioning software processes for resetting an accumulator accordingly over the appropriate time period.

A patient's diet as tracked by the system will be that conforming to the composite diet most recently selected for the patient as discussed above in reference to patient diet data 305, as modified by restrictions specific to the patient as discussed above in reference to restriction data 309, and which further, in some embodiments, meets the dietary requirements as discussed above in reference to patient nutrient data 320.

Patient data record 301 further comprises tray data 332, including a tray time stamp 334 for the time of entry of the tray data record 332, the location 336 at that time of any tray pending delivery, and the status 338 at that time of the tray, such as “order entered”, “order printed by kitchen operator”, “tray in preparation”, “delivery en-route” and the like.

Patient data record 301 further comprises meal history data 340, providing information regarding patient's meal orders 342 keyed by date 344. In some embodiments, meal history data 340 may merely be a record of information on the most recently ordered meal for the patient. Alternatively, meal history data 340 may track a number of the patient's previous meal orders.

Patient data record 301 further comprises snack access data 346, with boolean indicators as to whether the patient will have a morning snack 348, an afternoon snack 350, or an evening snack 352.

Further, embodiments of the present invention include notes 354 that may be entered in the patient data record by institution staff from time to time, including observations, measurements, instructions, and other information that may be useful in managing the patient's diet.

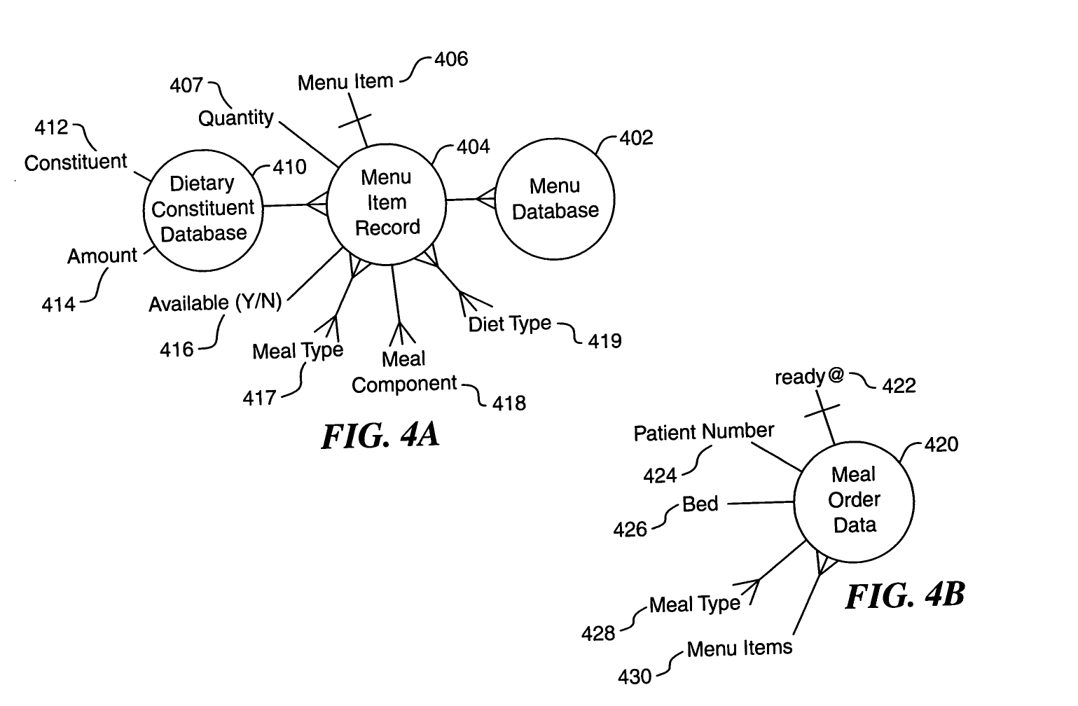

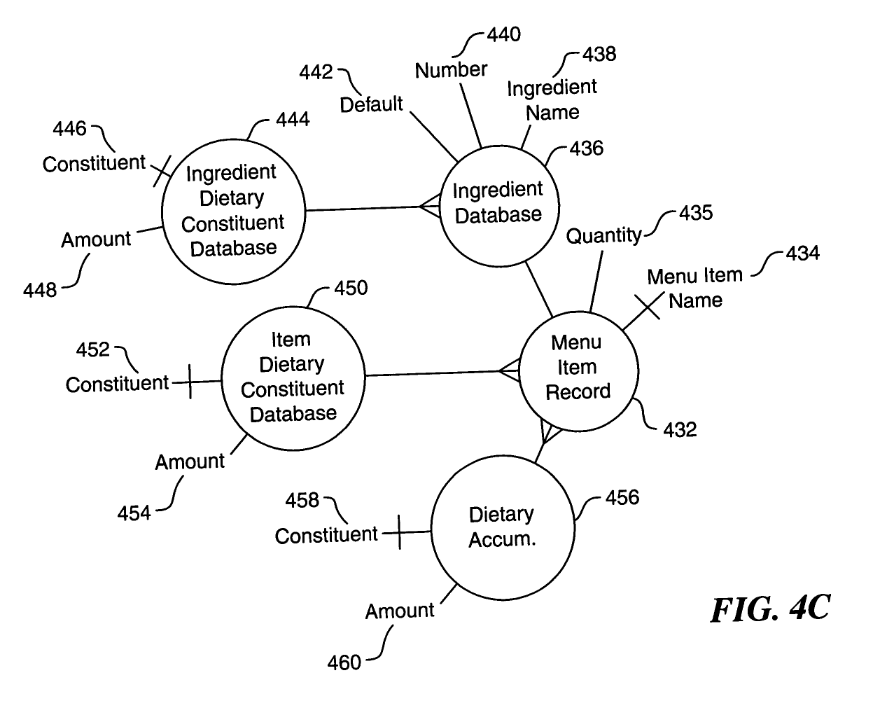

Turning now to FIG. 4a, depicted is an entity relationship diagram for menu database 402, containing menu item dietary value records. Each menu item record 404 in database 402 is keyed by the menu item 406, along with the quantity 407 of such menu item ordered. The menu item record 404 further comprises a list of dietary constituents from dietary constituent database 410 for menu item 406. For each menu item 406, the record in dietary constituent database 410 comprises the amount 414 of each dietary constituent 412 of menu item 406. The specific constituents 412 chosen for representation in dietary constituent database 410 and the dietary values 414 of such constituents in menu item 406 are determined by institution dietary staff based upon the staffs professional knowledge and expertise in management of patient diets and the dietary content of foods.

In some embodiments, menu item record 404 further provides boolean information 416 on the present availability of any particular menu item 406. Such information may be updated by way of a running inventory kept for menu items as they are received and used in patient meal preparation, typically on a system separate from the present invention.

Menu item record 404 further comprises meal type information 417, designating the meal type or types for which the menu item 406 is appropriate, such as breakfast, lunch, dinner, holiday meal and the like. As stated earlier in reference to FIG. 3, there are a fixed number of meal types, depending on the needs of the institution. Further, a given menu item 406 may be appropriate for several meal types 417.

Menu item record 404 further comprises meal component information 418, designating the classification of meal item 406 as a component of a meal, such as entree, vegetable, dessert, side dish, etc. Dietary staff in the institution determine a fixed number of meal component classifications, principally for menu and dietary management purposes. Menu item record 404 yet further comprises meal item diet type information 419, whereby the institution's dietary staff have designated the menu item as appropriate in one or more diet regimens provided by the institution, as described above in reference to FIG. 3.

Turning to FIG. 4b, illustrated is meal order data. Each meal order data record 420 in a meal order database is keyed by the ready@ entry 422 for the patient's meal, indicating the time the order is expected to be delivered to the patient. Meal order data record 420 further comprises the system patient number 424 ; in some embodiments, the patient's current bed 426 ; meal type 428, such as breakfast, lunch, dinner and the like; and a list of menu items 430 selected for the patient for that meal. Meal order data permits the processing of patient meal orders for meal preparation as well as the tracking of meal history (see Meal History Data 340 in FIG. 3) implemented in some embodiments of the invention.

For scheduling fulfillment of patient's orders, the meal order database is sorted by ready@ time. In some embodiments, institution kitchen staff may simply periodically manually request the kitchen printer to print out those orders with the soonest ready@ time. In other embodiments, the system may automatically periodically batch process the meal order database and print out those meal orders having ready@ times within some specified period, say 20 to 40 minutes.

In the exemplary embodiment, in the meal order database the patient for any meal is identified by patient number. In some of such embodiments, meal order data record 420 does not need to have a current bed 426, because, when meal orders are printed out, that data is obtained from the patient database based upon the patient number in the meal order. Advantageously in such embodiments, if the patient has been moved between the time the order was placed and the time of fulfillment, the patient's order as printed in the kitchen will have the patient's present room, enabling meals to be delivered to the proper patient even when the patient has moved after the order was placed.

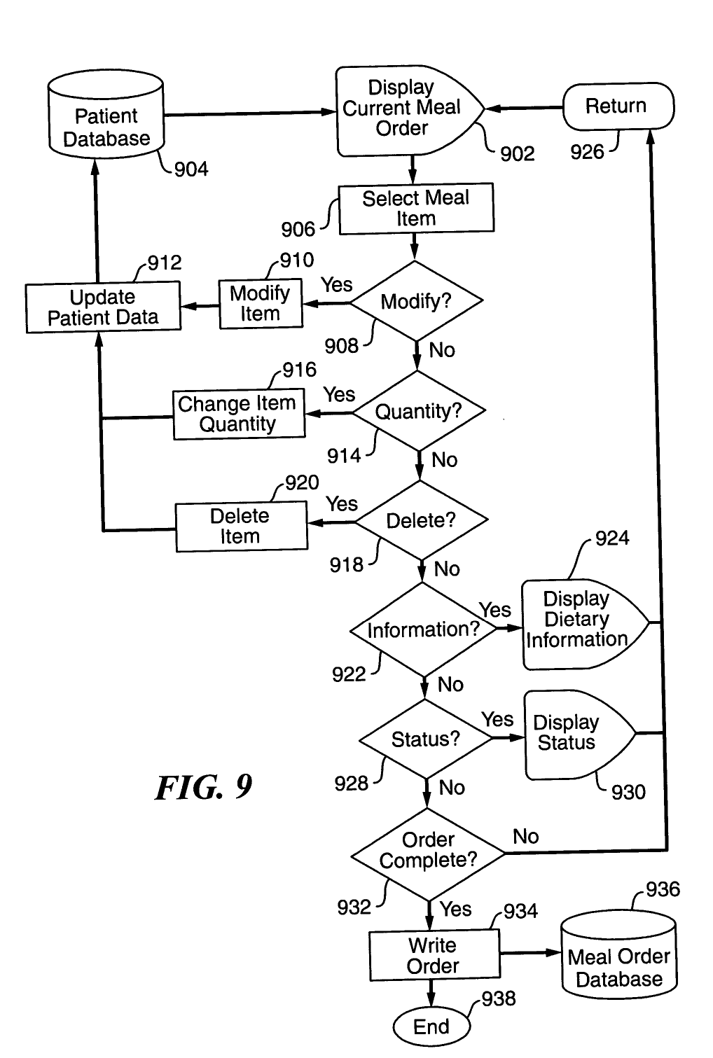

FIG. 4c illustrates an alternative data structure for the menu database discussed with reference to FIG. 4a above. Embodiments employing this data structure permit meal orders of menu items whose ingredients may vary, and are discussed in more detail below in reference to FIG. 9.

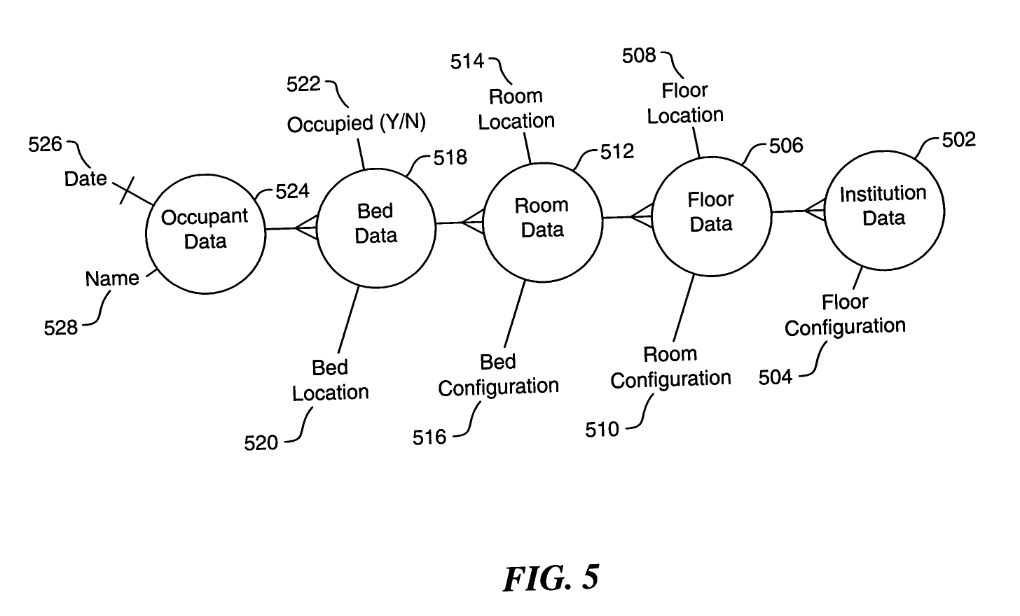

FIG. 5 shows an entity relationship diagram for bed data in the institution, depicted as organized at four levels of detail. As will be appreciated by those of skill in the art in light of the following description, the number of levels of detail in the organization of bed data may be varied to suit the needs of a specific institution without departing from the spirit of the present invention. In the depicted embodiment, institution bed data 502 comprises records for a plurality of floors 506 or other convenient sectional division of the institution such as wings, wards, and the like. For each such division 506 are records 512 for a plurality of rooms. For each room, there is a record 518 for each bed in the room, with a boolean entry 522 indicating whether or not the room is presently occupied, and occupant data 524 for patients in the room. An occupant database entry 524 is keyed by the date 526 such record is entered and comprises the identity 528 of the patient entered on that date, permitting a historical report of room occupancy.

At the bed level of detail 518, boolean entry 522 and occupant data 524 are updated as patients check into the institution, are moved from bed to bed within the institution, and are checked out of the institution. Referring back to FIG. 2, such updating of the database system may either be by direct entry of patient and room data via computers 216, 218, 230, 238, and so on, that are networked on the system, or such updating may be the result of processing by the system of data received via interface 224 from hospital management system 226.

Returning to FIG. 5, in some embodiments at each level of detail there may be configuration data allowing a graphic representation of the next level of detail. As illustrated, at the institution level 502, there is floor configuration data 504, facilitating a graphic representation of floors in the institution. Similarly, at the floor data level 506, there is room configuration data 510, facilitating a graphic representation of rooms on the floor. Again similarly, at the room data level 512, there may be bed configuration data 516, facilitating a graphic representation of beds in the room. Supporting such embodiments, a record at each level of detail has information concerning its location at that level of detail, so that a floor data record 506 has its location 508 in the floor configuration data 504 for the institution. Similarly, a room data record has its location 514 in the room configuration data 510 for its floor 506. Again similarly, a bed data record has its location 520 in the bed configuration data 516 for its room 512.

As will be appreciated by those of skill in the art, the details of data structures describing configuration data 504, 510, 516 in any given embodiment will in general be specific to the software implementation of the user display interface for that embodiment. It will be further appreciated by those of skill in the art that embodiments according to the teaching of the present invention may vary greatly in the detail with which configurations are graphically represented. In some embodiments, some levels of detail, such as the institution level 502 or the room level 512, may be presented to the user with no graphical representation. The preferred embodiment of the present invention enables at least a graphical depiction of rooms on a floor or similar division.

The foregoing descriptions of entity relationships in the databases comprising the present invention should be understood as only illustrative of relationships in the data that is managed by the system, rather than as specific instructions for the structure of such data. Based upon an understanding of these relationships, specific data structures supporting the database management and user interface required by the system may be crafted by persons of ordinary skill in the software arts without undue difficulty. Such specific crafted data structures need implement only the illustrated relationships; they need not reflect the apparent structure of elements comprising the depicted relationships.

For example, a number of individual data items occur more than once in several of the foregoing descriptions. By way of illustration, referring to FIG. 3, patient name occurs as item 303 in patient data 301, while in FIG. 5 patient name occurs as item 528 in occupant data 524. As is well known to those of skill in the software art, however, redundant occurrences of an individual data item may be replaced by pointers to a single instance of the data item, and therefore data structures in some embodiments of the present invention may contain pointers to memory containing redundant values rather than actual values themselves.

By way of further example of how the illustrated relationships may be implemented by persons of skill in the art, some data items may not need to be stored in memory because their functionality when needed may be replaced with algorithmic operations upon other data items. For example, if the patient name 528 (FIG. 5) in an occupied room data record 524 is a pointer to the patient name 303 (FIG. 3) in the patient database, and if patient name pointer 528 is replaced by the null pointer as a bed is vacated, then the functionality of boolean occupancy indicator 522 may be replaced by algorithmic operation as in pseudo-code set forth in Table 1.

TABLE 1

```
if room.name = null\hat{ } then
  set room.occupied to FALSE
else
  set room.occupied to TRUE
```

By employing these and other crafts well known to those of ordinary skill in the computer arts, the relationships described in the foregoing discussion may readily be reflected in specific database and software programmatic implementations of the present invention.

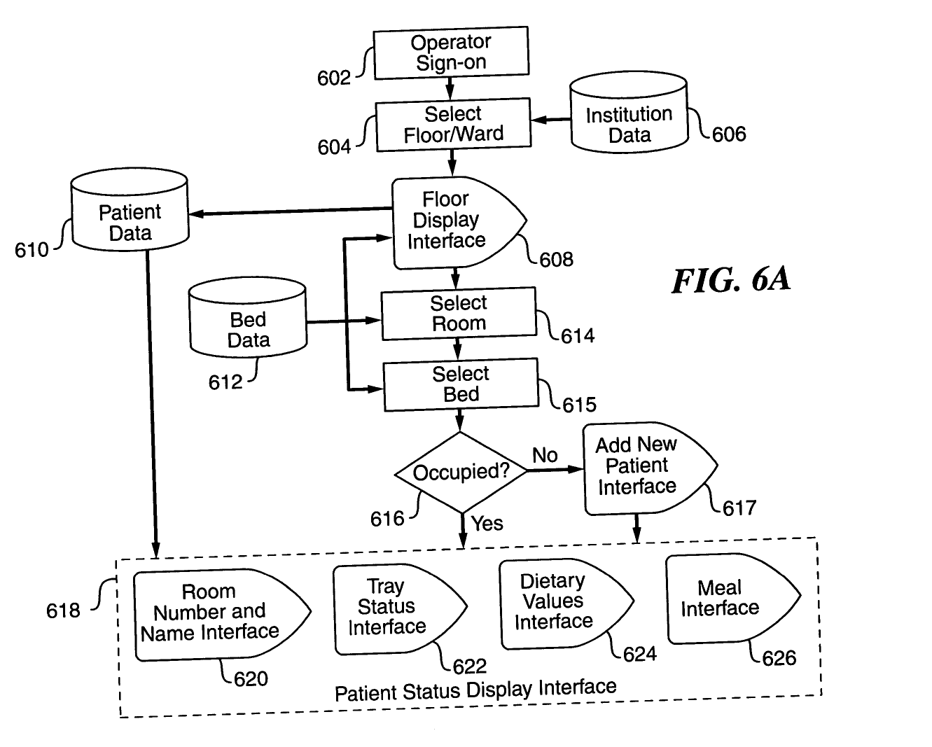

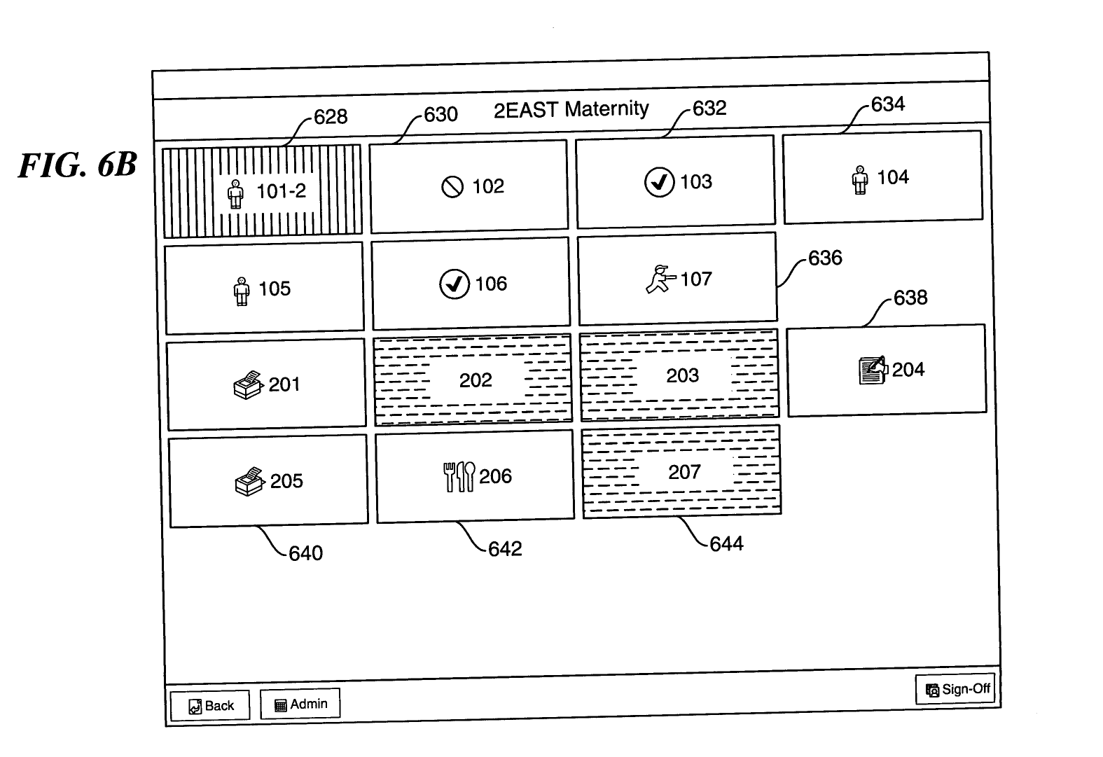

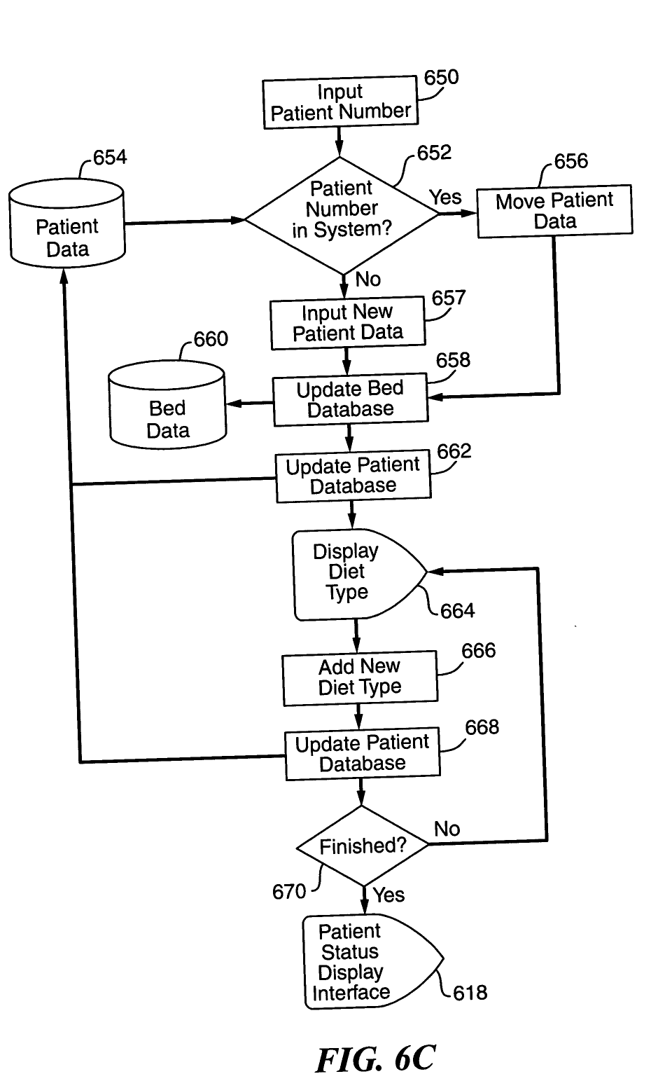

Turning now to the method of use of the present invention, FIG. 6 illustrates a flow chart of an embodiment of the present invention for an operator to use the system for its principal functions in the patient status display interface.

In 602, the operator signs on to the system. Because the system contains data specific to identified patients, there are significant privacy concerns pertaining to access to such data, as well as regulatory requirements for safeguarding patients' privacy, such as required under the Health Insurance Portability and Accountability Act of 1996 (HIPPA). To address such concerns, logon 602 should assure that only authorized users access the system by employing authentication means well known to those of skill in the art, such as password protected access, hardware access keys, or biometric user verification.

To access patient status data, the user selects a floor, wing or ward of interest at 604 from a display of such items obtained from institution data 606. Having selected a floor, the user is presented with the floor display interface 608. Utilizing bed data 612, interface 608 presents a graphic representation of rooms on the floor or other division in question, as discussed earlier in reference to FIG. 5. The graphic representation of each room may present various information about the room, such as room number, occupancy status and meal order status. Information may be conveyed graphically in various ways, such as by written text, by colors, or by icons, as is well known in the art. Preferred embodiments employ a graphic user interface, in which each room on the selected floor will have a portion of display dedicated to interface functions for that room. Furthermore, in some embodiments rooms may be presented in display 608 in approximately the same layout as their actual location on the floor, enabling the user to identify quickly the portion of display 608 representing any particular room.

FIG. 6b shows an exemplary floor display interface 608 for fourteen rooms on Floor 2 East Maternity. In the display, rooms are represented as rectangles that are coded by text, color and icons. Each room rectangle contains the room number in text. In the room labeled 628, the text “101-2” further indicates that this patient has missed two meals. Room rectangle 628 is further displayed in a red color to alert the user that the occupant has missed meals.

Room rectangle 630 contains a slashed circle icon indicating that no meal is allowed for this patient (NPO—no orders allowed). Room rectangle 632 contains a check mark icon indicating that there is a patient in the room but there is no meal order outstanding. Rectangle 634 contains a person icon indicating that there is a patient in the room and no meal order has been taken yet. The running delivery-person icon in rectangle 636 indicates that a meal order for the patient has left the kitchen. In rectangle 638, the handwriting icon indicates that an order has been taken but has not yet been printed for fulfillment in the kitchen. The printer icon in rectangle 640 indicates that the present order has been printed in the kitchen. The dinnerware icon in rectangle 642 indicates the meal has been delivered to the room. When the patient has finished the meal and the tray is cleared, staff will so designate the tray status for the room and the room rectangle will again display a check mark icon as in 632, indicating there is a patient in the room but no present meal order, until the next meal is ordered for the patient. Shading for rectangle labeled 644 indicates the room is empty.

Returning to FIG. 6a, a user may request additional information about a particular room or the patient therein by selecting the room in the floor display interface at step 614. In preferred embodiments employing a graphic user interface (gui), the user makes such selection by a standard gui convention, widely employed by those of skill in the art, such as mouse point-and-click on the area of the display specific to the room. In some embodiments most applicable to institutions having multiple beds in patient rooms, having selected the room the user may further select the bed of interest in the room via step 615.

In any case, having designated the bed of interest, the system determines at 616 whether the bed is occupied. If the bed is occupied, the system presents the patient status interface 618 described in greater detail below. If the bed is not occupied, the system presents the Add New Patient Interface 617.

Turning now to FIG. 6c, the Add New Patient Interface 617 is shown. At 650 the user enters the patient number assigned to this patient by the hospital management system. At 652, the invention queries patient database 654 as to whether this patient number is in its system. If the patient number is in the system, then at 656 the system moves the patient data to this room, by simply changing the bed data in the patient data record and appropriately updating at 658 the bed database 660 and updating at 662 patient database 654. If the patient number is not in the system, the user inputs patient data at 657 for updating 658 bed database 660 and updating 662 patient database 654.

Having obtained the identity of the patient in the room, interface 617 further permits specification of the diet types appropriate for the patient. The interface presents the user at 664 with list of diet types, if any, selected for the patient, and a list of available diet types. Interface 617 allows the user to add a new diet type at 666, updating the patient database record at 668. Interface 617 loops at 670 back to displaying at 664 the data types selected for the patient, exiting to the patient display status interface 618 (FIG. 6a) when finished.

Returning to FIG. 6a, patient status display interface 618 comprises four principal components: room number and name interface 620; tray status interface 622; dietary values interface 624; and meal interface 626. These components in the depicted embodiment exemplify a specific implementation of the principal functions of the present invention. It will be clear to those of skill in the art that the particulars of implementation may be varied considerably by software and database design techniques well known in the art, and yet remain within the spirit of the present invention.

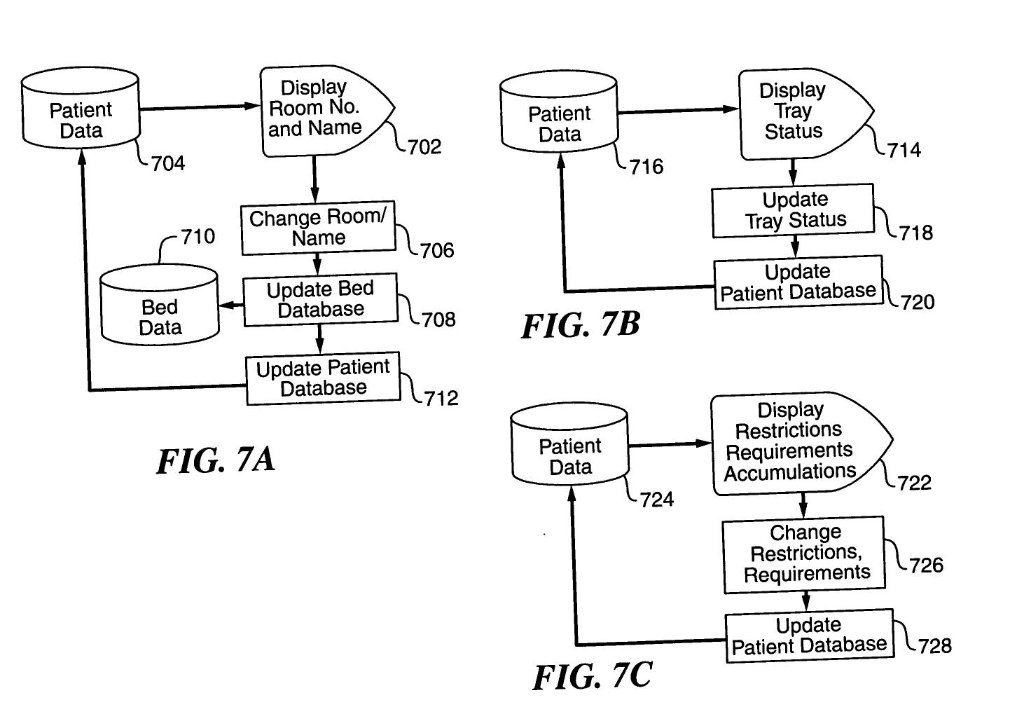

Turning to FIG. 7a, a flowchart is depicted for the functionality of the room number and name interface of the patient status interface. The assigned room number and name of the patient in the selected bed are obtained from patient data 704 and displayed 702. As discussed earlier, a patient's assigned room may change during the patient's stay at the institution. Further, a patient may leave the institution. In any case, such changes require a database change indicating a new patient for a given bed or a new bed for a given patient. The user may change either the patient assigned to the room or the room assigned to the patient at 706. In either case, upon the user's making such a change, the bed database 710 is updated at step 708 and the patient database 704 is updated at 712.

FIG. 7b shows the tray status interface, displaying at 714 the tray status obtained from patient database 716. At least the current status of a tray pending delivery to the patient is displayed 714, but preferred embodiments show the set of tray status records for a tray pending delivery, preferably sorted by time of record entry. As discussed earlier in reference to FIG. 2, embodiments of the present invention permit entry of tray status data by scanning. However, the tray status interface also permits manual entry of tray status data at 718, such as might be done at a nurse's station when a tray is received or delivered to the patient's room, thereby updating 720 patient database 716.

FIG. 7c depicts the dietary values interface, wherein the values entered for the patient's dietary restrictions and, if applicable, dietary requirements are displayed at 722 from information obtained from patient database 724. Restrictions and/or requirements for the patient may be changed by the user at 726, updating at 728 patient database 724.

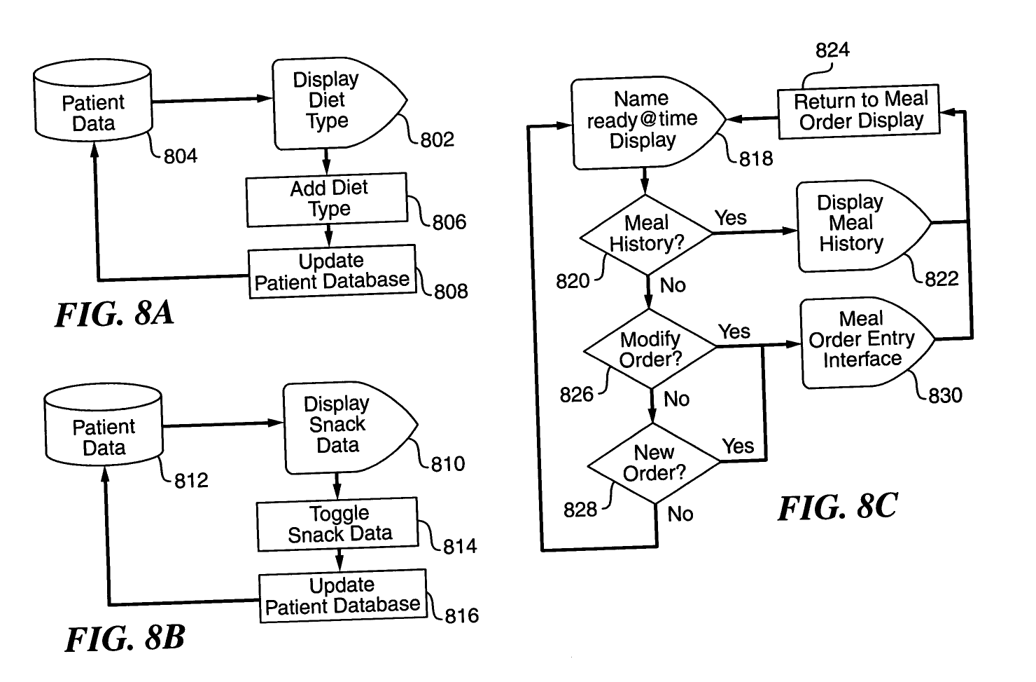

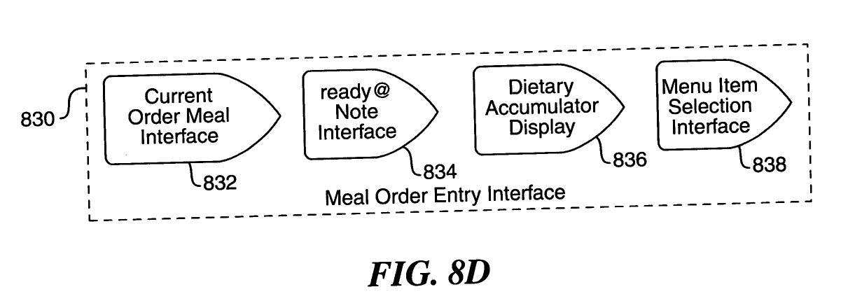

In this embodiment, the meal interface (item 626 in FIG. 6) comprises three parts. The first part, depicted in FIG. 8a, is a diet type interface. Diet types are discussed earlier in reference to FIG. 3. The interface displays at 802 the history by date of diet types selected for the patient obtained from the diet database. The user may change the current diet for the patient by adding a diet data entry at 806, updating at 808 patient database 804. The most recent diet data entry in patient database 804 is used by the system to determine patient's current diet type. As discussed earlier in reference to FIG. 3, in some embodiments the patient diet type may be a composite of several diet types established by the institution.

The second part of the meal interface is the automatic snack interface. Referring to FIG. 8b, the interface displays at 810 the snacks designated for the patient from information obtained from patient database 812. The user may toggle at 814 whether or not a particular snack (e.g. from among the morning snack, the afternoon snack and the evening snack) is designated to be provided. In a typical gui implementation, the user toggles snack information by checking or unchecking an appropriate box in the snack interface area of the patient data display by gui convention, such as pointing and clicking the check box for the designated snack. When snack information is toggled, the snack interface updates at 816 the relevant date in patient database 812.

The third part of the meal interface is the meal order display, depicted in FIG. 8c. Displayed at 818 are the name and ready@ time for the most current meal order. The meal order display further permits the user to request a meal history display at 820. If a meal history is requested, a history of meal names by ready@ time for the patient is displayed at 822, from which the user may return 824 to the meal order display 818. The meal order display yet further permits the user either to modify the current meal order at 826 if fulfillment has not yet begun or to enter a new meal order at 828, either of which will invoke meal order entry interface 830, described in greater detail below. After meal order entry, the user is returned 824 to the meal order display 818.

Turning to FIG. 8d, meal order entry interface 830 comprises four parts: current meal order interface 832 ; ready@ and note interface 834 ; dietary accumulator display 836 and meal item selection interface 838. Each of these parts is discussed in greater detail in reference to FIG. 9.

Turning to FIG. 9, portraying the current meal order interface, displayed at 902 is the current meal order data from patient database 904, comprising a list of menu items making up the current order. At 906, the user may select one of the menu items displayed at 902, such selecting performed according to the software implementation by tabbing and highlighting, mouse pointing and clicking, or other selection method well known to those of skill in the software art. Upon selecting a menu item at 906, a user may perform a number of actions regarding the item. If the meal order has not yet been printed for fulfillment by kitchen staff (refer back to FIG. 2), the present invention enables a user to make changes in menu items making up the current order. Menu items may not be changed, however, if the meal order has already been printed. In preferred embodiments of the present invention, therefore, the meal order interface disables the user's ability to access functions for changing meal orders after a meal order has been printed. Other functions are still enabled for an order that has already printed, however.

In some embodiments, as shown here at 908, a user may modify the menu item. In such embodiments, a menu item is comprised of component ingredients. Selecting modify at 908, a user may select at 910 among component ingredients in the selected menu item. For example, if the selected menu item is “hamburger”, ingredients may comprise a selection of buns, from “whole wheat” to “sesame seed”, and a selection of condiments and additions, including mustard, mayonnaise, and various cheeses. For such an embodiment, a user selection of “modify” at 908 allows the user to add or delete component ingredients making up the menu item. As ingredients are added or deleted, the dietary accumulator display discussed in reference to item labeled 836 in FIG. 8d below is updated accordingly. As will be noted by those of skill in the art, the exemplary data structure shown in FIG. 4a for the menu database will require some additional detail to support embodiments featuring such modification capability. Such additional detail may be provided by those of skill in the art by employing any of several well-known software practices to create a supporting data structure, such as illustrated in FIG. 4c

Turning for the moment to FIG. 4c, menu item record 432 is keyed by menu item name 434, with the quantity 435 of such menu item ordered. It further comprises a data structure for the database of ingredients 436 making up menu item 432. Each entry of ingredient data 436 comprises the name 438 of the ingredient, the variable number 440 of such ingredient in the selected menu item, and the default number 442 of such ingredient in menu item 432. Further, each ingredient database record 436 comprises a database 444 of dietary constituents 446 and relevant amounts 448. In addition to the ingredient database, the menu item record comprises its own dietary constituent database 450, for amounts 454 of the dietary constituents 452 in the menu item 432 apart from those in ingredients listed in ingredient database 436. Menu item record 432 further has a dietary accumulator 456 for accumulating dietary values 460 of constituents 458 in menu item 432 as selected and modified.

When modification of a menu item record is selected, the number 440 in the database 436 for each ingredient is initially set to the default number 442 for such ingredient. As menu item 432 is modified, the number 440 for the relevant ingredient record 436 is modified accordingly, from zero for no selection of such ingredient to however much of such ingredient is requested. The displayed dietary accumulator for the patient discussed in reference to 9c below is updated according to each modification of the menu item record by accumulator 456 for the menu item record, as follows. The value 460 in the accumulator 456 for any constituent 458 comprises a sum of the amount 448 of such constituent 446 for each ingredient 436 times the number 440 of such ingredient 436 in the selected menu item 432, plus the amount 454 of such constituent 452 for the menu item 432 apart from its ingredients 436. Just as in FIG. 4a, menu item record 432 will also have data for availability, meal type, meal component and allowable diets (for clarity, not shown in FIG. 4c).

The interface for actually making modifications to a meal order is the meal item selection interface, numbered 838 in FIG. 8d above and discussed in greater detail below. For the present discussion, though, returning to FIG. 9, when the modification at 910 is complete, the system updates at 912 patient data record 904 with appropriate meal order data and displays the changed current meal order at 902.

From current meal order display 902, a user may choose to change the quantity of a selected menu item at 914. If the quantity of a selected menu item is changed at 916, the menu item record in the meal order data in patient database 904 is updated 912 to reflect the changed quantity of the selected item and the changed current meal order is again displayed at 902.

From current meal order display 902, a user may choose to delete a selected menu item at 918. If the menu item is deleted at 920, the menu item record in the meal order data is deleted, the meal order data in patient database is updated at 912, and the changed current meal order is again displayed at 902.

A user may request information about the selected item at 922. If such information is requested, a small display of key dietary information about the item, obtained from the menu item record in the meal order data in patient database 904, is shown at 924, after which the user may return at 926 to the current meal order display 902.

A user may further request the current status of the meal order at 928. Status display 930 may include information from the patient database such as the original entry time for the current meal order, the last time it was modified, the patient's name and currently assigned room number, the patient's diet type, the meal type of the present order and its current ready@ time. After viewing display 930, the user may return 926 to the current meal order display 902.

If the meal order is complete, the patient may so designate at 932, causing a meal order data record to be updated or added to a database 936 of orders at the institution, after which the user is returned at 938 to the room display interface discussed above with reference to FIG. 6a.

Meal order entry interface further comprises ready@ and note interface, shown as 834 in FIG. 8d. This interface allows the user to change the time the meal order is requested to be delivered by changing the ready@ time for the order. It further allows the user to add notes to the patient's meal order for later reference. Such notes may comprise, for example, observations of the patient's intake of the meal in question.

Meal order entry interface further comprises dietary accumulator display, shown as 836 in FIG. 8d. This display shows the current values of accumulations of dietary constituents from the patient database. Significantly for the functionality of the present invention, this display is updated every time a menu item is added, changed or deleted. In preferred embodiments, a warning is given and a given dietary component is highlighted when its value exceeds (or in some embodiments, merely approaches) the restriction data for that component for that patient. Thereby, the user may monitor dietary accumulations and advantageously modify meal orders to keep dietary accumulations below restricted levels. As will be clear to those of skill in the art, in a similar vein for embodiments tracking accumulations of dietary requirements, a suitably fashioned dietary accumulator display may be crafted without undue effort that will permit a user advantageously to select meal orders for a diet meeting dietary requirements of the patient.

Meal item selection interface, numbered 838 in FIG. 8d, shows menu or ingredient items and allows the user to select among such items, adding or changing components of the current meal. In preferred embodiments of the invention, meal item selection interface 838 will display only items permitted on the diet type for the patient in question, by referring to the allowed diet types in the menu item record for the meal item and comparing them to the patient's diet type from the patient database record. When a user selects a displayed item, the system updates the meal order displayed in the current meal order interface 832 and the dietary accumulator display 836. In embodiments permitting user selection of meal item ingredients, selection of a meal item will automatically place the user in a similarly configured display interface for selecting allowed ingredients for the selected meal item. Upon completing meal item selection, the user indicates selection is complete and is returned to the current meal order interface.

As is clear from the foregoing discussion, the meal interface of the patient status interface enables a wide variety of functions directed at ordering a patient's meal and monitoring the patient's dietary intakes. Persons of skill in the art will appreciate that the present invention permits the user to determine and order components of patients' meals so that each patient's intake of dietary constituents is controlled to a fine degree of specificity for that patient.

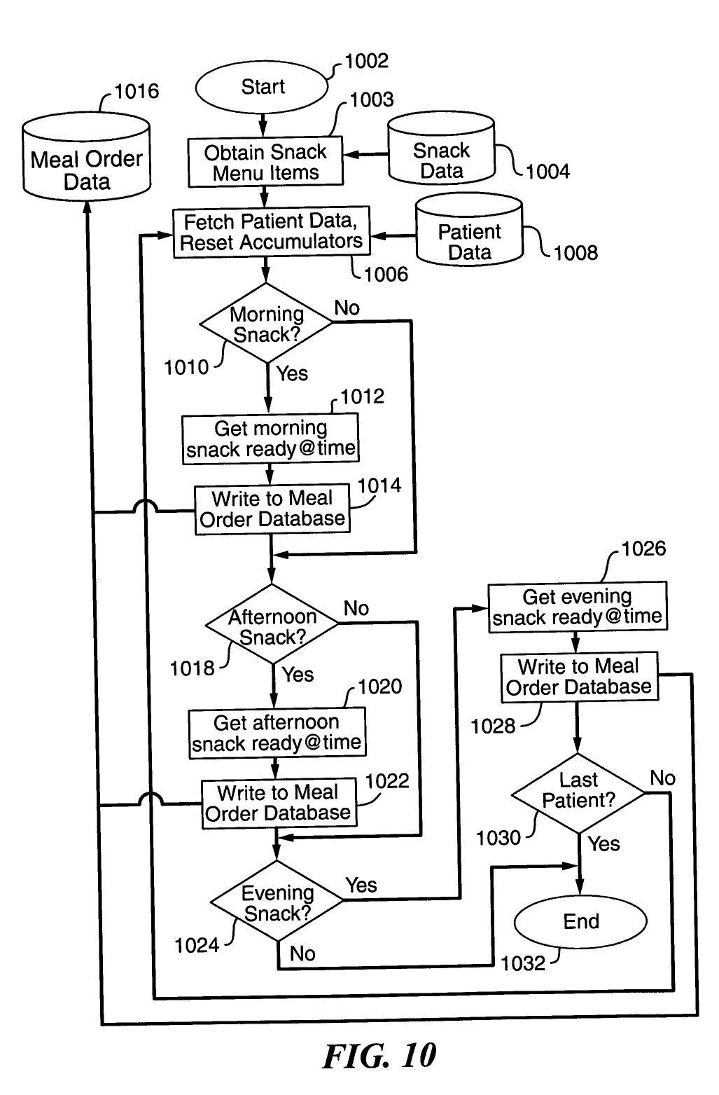

Periodic batch processing of patient data is required for the system to reset dietary accumulators and to create automatic snack orders for patients. FIG. 10 portrays an embodiment for batch processing to reset dietary accumulators and order snacks daily. Starting at 1002, the system obtains snack menu items at 1003 from a snack database 1004. Snack database 1004 contains the menu item data for each of the morning, afternoon and evening snacks. In the illustrated example, there is a single snack database record for each of the three snacks. However, as will readily be understood by those of skill in the art, the data structures and software may be modified so that one of several possible snacks may be selected based upon availability or data specific to the patient.

Next, the system fetches at 1006 a patient data record from patient database 1008 and resets the dietary accumulators. Using snack access data from the patient data record, the system determines 1010 whether or not the patient gets a morning snack. If the patient is to receive a morning snack, the system obtains at 1012 a ready@ time for the morning snack. In some embodiments, the ready@ time used in 1012 is the same for all patients. In some other embodiments, for the purpose of simplifying snack preparation and distribution, the ready@ time may be varied for groups of patients. In some embodiments as well, the ready@ time for snacks may be determined by some patient-specific data. In any case, the menu item data and ready@ time is written at 1014 as a meal order entry in meal order database 1016 for later processing by the system and fulfillment by hospital staff. Similar processes 1018, 1020, 1022 are used for the afternoon snack and at 1024, 1026 and 1028 for the evening snack. At 1030, the system loops back to 1006 to fetch a new patient data record until all patient data records have been processed.

Periodic batch processing of data facilitates many tracking functions of the system. For example, periodic batch processing of patient meal order data permits the system to process and display information on rooms whose patients have not ordered meals over a certain period of time, as noted with reference to the room labeled 628 as discussed with reference to FIG. 6b above. Such information may be of interest to medical as well as dietary staff. Further, batch processing of patient tray data permits the system to process and display information showing meals that are overdue to patients, by noting tray data with status indicating the meal is to be delivered to the room but whose ready@ time has already passed. By obtaining such information on overdue meals, hospital administrative staff may more efficiently assure the timely delivery of patients' meals. Further, batch processing of patient tray data permits the system to process and display information concerning rooms having trays that need clearing, by noting which rooms show a tray having been delivered some time ago, say an hour, but do not yet show the tray having been cleared from the room. Such information enables hospital staff to assure thorough and timely clearing of patient food trays from patient rooms.

It will be clear to those in the art that other processes are necessary to implement the functionality of the system, principally being those processes needed to create and maintain institution data and menu data comprising meal item data. Such processes are not specified in detail here because they may be readily crafted by persons of ordinary skill in the art using well established conventional techniques in software and database design.

Conclusions, Summary and Scope

As is clear from the foregoing detailed description of preferred embodiments, the present invention provides means for a user to inquire, obtain and modify detailed information regarding: vacancy status of facility beds; identity of a patient in an occupied bed; in some embodiments at least the most recent meal ordered for a patient; the status and location of a meal tray, if any, from order fulfillment and tray preparation to delivery to the patient's room to clearing of the tray from the room; the patient's current accumulated intake levels of restricted dietary constituents; and, in some embodiments, the patient's current accumulated intake values of dietary requirements. Furthermore, the present invention provides for ordering patient's meals and modifying a patient's meal order while maintaining fine control over the patient's dietary intake accumulations.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1. An automated method of taking and fulfilling patient meal orders at an institution, comprising
taking the patient's meal order; and
tracking the patient's accumulations of dietary constituents based upon patient meal orders.

2. An automated method of taking and fulfilling patient meal orders at an institution according to claim 1, further comprising
specifying a diet for the patient.

3. An automated method of taking and fulfilling patient meal orders at an institution according to claim 2, wherein said step of specifying a diet for the patient further comprises selecting one or more diet types for the patient from a list of diet types.

4. An automated method of taking and fulfilling patient meal orders at an institution according to claim 2, wherein said step of taking the patient's meal order comprises selecting items presented from a menu, the presentation of which is determined by the diet specified for the patient.

5. An automated method of taking and fulfilling patient meal orders at an institution according to claim 1, further comprising specifying limits of designated dietary constituents for the patient.

6. An automated method of taking and fulfilling patient meal orders at an institution according to claim 5, wherein said step of taking the patient's meal order further comprises monitoring incremental contributions of meal order selections to the patient's accumulation of dietary constituents and providing a warning if a meal order selection causes an accumulation to exceed a specified limit for a designated dietary constituent.

7. An automated method of taking and fulfilling patient meal orders at an institution, comprising
taking the patient's meal order;
processing the patient's meal order; and
tracking the status of the patient's meal order.

8. An automated method of taking and fulfilling patient meal orders at an institution according to claim 7, wherein said step of processing the patient's meal order comprises filling the order by preparing a tray for the patient.

9. An automated method of taking and fulfilling patient meal orders at an institution according to claim 8, wherein said tray is given a unique identifier and said step of tracking the status of the patient's meal order comprises tracking the tray by the unique identifier.

10. An automated method of taking and fulfilling patient meal orders at an institution according to claim 7, wherein said step of tracking the patient's meal order comprises entry in a database of the status of the patient's meal order.

11. An automated method of taking and fulfilling patient meal orders at an institution according to claim 10, wherein the status entered in the database indicates a meal order status selected from the group consisting of meal order taken but not yet fulfilled, meal order fulfilled but not yet delivered, meal order delivered, and meal order cleared.

12. An automated system for monitoring the dietary intake status of a patient at an institution, comprising
a database of patient information, including patient location and patient dietary status;
a display showing patient dietary status for a plurality of patients by patient location; and
a user interface to select a patient of interest from the plurality of patients displayed.

13. An automated system according to claim 12, wherein said database further includes information on the patient's diet.

14. An automated system according to claim 13, wherein said information on the patient's diet comprises a diet type selected for the patient.

15. An automated system according to claim 14, further comprising a user interface to select a selected patient's diet type from a list of diet types.

16. An automated system according to claim 13, wherein:
said information on the patient's diet comprises designated patient intake amounts for selected dietary constituents, said intake amounts comprising at least one of restricted amounts and recommended amounts for each such dietary constituent; and
said system further comprises a user interface to select dietary constituents and designate constituent intake amounts thereof for a selected patient.

17. An automated system according to claim 12, further comprising a means for tracking dietary constituents of a patient's meals at the institution.

18. An automated system according to claim 12, further comprising a means for ordering a patient's meals at the institution.

19. An automated system according to claim 12, further comprising an interface to specify meals and to place an order for a meal for a patient at the institution.

20. An automated system according to claim 19,
further comprising a database of meal menu items, at least some dietary constituents of at least some menu items, and the amounts of such dietary constituents in such menu items,
wherein the interface to specify meals for a patient comprises selection of meal menu items from the meal menu item database.

21. An automated system according to claim 20, wherein
said database of patient information further comprises information on the accumulation of dietary constituents by the patient; and
said dietary accumulation information is updated with menu item dietary constituent amount information from the meal menu item database as meal menu items are selected.

22. An automated system according to claim 21, wherein
said interface to specify meals further comprises a display of said dietary constituent accumulation information.

23. An automated system according to claim 21, wherein
said interface to specify meals further presents an alarm when a selected meal menu item causes the patient dietary accumulation for a constituent to exceed a predetermined value for such constituent.

24. An automated system according to claim 23, wherein
said patient database further comprises designated patient intake restrictions for selected dietary constituents; and
the predetermined value causing the alarm in the interface to specify meals is based upon the designated patient intake restriction for a selected dietary component.

25. An automated system according to claim 23, wherein
said patient information database further specifies, for at least some patients, at least one selected diet type appropriate for the patient; and
the predetermined value causing the alarm in the interface to specify meals is based upon the at least one selected diet type appropriate for the patient.

26. An automated system according to claim 21, wherein said interface to specify meals allows a user to change a selected meal item based upon the patient's dietary accumulation information before placing the patient's meal order.

27. An automated system for managing the meal order and dietary intake status of a patient at an institution, comprising
database of patient information, including at least one diet type designated for a patient;
a database of meal menu items, comprising, for at least some of such menu items, at least one diet type appropriate for such menu item;
a user interface to specify meals for a patient at the institution comprising selection of presented meal menu items from the meal menu item database;
wherein the presentation of a meal menu item in the interface is determined by the at least one diet type designated for the patient and the diet types for which the menu item is appropriate.

28. An automated system for monitoring the meal order status of a patient at an institution, comprising
a database of patient information, including patient location and meal order status;
a display showing patient meal order status for a plurality of patients by patient location and
a user interface to select a patient of interest from the plurality of patients displayed.

29. An automated system according to claim 28, wherein the meal order status comprises the status of the patient's meal tray for those patients for whom meal trays have been prepared.

30. An automated system according to claim 29, wherein the tray status comprises the location of the tray at the institution.

31. An automated system according to claim 28, further comprising an interface to enter the meal order status of a selected patient.

32. An automated system according to claim 28, further comprising an interface for entering and changing the location of a designated patient.
